(19) United States
(12) Patent Application Publication
(10) Pub. No.: US 2009/0130297 A1
(43) Pub. Date: May 21, 2009

(54) Organic EL Material, Organic EL Device Using the Same, and Method for Producing Organic EL Device

(75) Inventors: Shinji Matsuo, Fukuoka (JP); Hideyuki Furumi, Fukuoka (JP); Hiroshi Miyazaki, Fukuoka (JP); Kazuo Ishii, Fukuoka (JP); Toshinao Yuki, Yamagata (JP); Tsuyoshi Naijo, Yamagata (JP)

Correspondence Address: BIRCH STEWART KOLASCH & BIRCH, PO BOX 747, FALLS CHURCH, VA, 22040-0747, US

(73) Assignees: Nippon Steel Chemical Co.Ltd, Tokyo (JP); Tohoku Pioneer Corporation, Yamagata (JP)

(21) Appl. No.: 11/887,250

(22) PCT Filed: Mar. 14, 2006
(86) PCT No.: PCT/JP2006/304975

§ 371 Date: Oct. 31, 2007

(30) Foreign Application Priority Data
Mar. 31, 2005 (JP) 2005 102782

(51) Int. Cl. B05D 5/12

(52) U.S. Cl. 427/66

(57) ABSTRACT

Disclosed are an aluminum chelate complex capable of stabilizing the degree of vacuum in a film-forming chamber in the vapor deposition step and producing efficiently a high-quality organic EL device which shows excellent reliability and durability in practical use and an organic EL device using the said aluminum chelate complex. The aluminum chelate complex useful as an organic EL material is represented by L¹Al(L²)₂, contains 0.6 mol % or less of a complex represented by Al(L²)₃, and is obtained by reacting an aluminum alkoxide with a quinolinol derivative and then with a phenolic compound and purifying the resulting complex to a high degree. In the formulas, L¹ denotes a phenolate ligand and L² denotes a substituted quinolinolate ligand.

### TECHNICAL FIELD

This invention relates to an organic electroluminescent device (hereinafter referred to as organic EL device) and to an aluminum chelate complex which is useful as an organic EL material to be incorporated in organic layers in the said organic EL device.

### BACKGROUND TECHNOLOGY

An organic EL device constituting an organic EL panel that is attracting attention as a promising display panel in the future generally has a layered structure constructed of a glass substrate as a display surface, a transparent electrode as a lower electrode (for example, the anode), plural layers of organic materials comprising a light-emitting layer, and an upper electrode consisting of a metal electrode (for example, the cathode), each prepared in thin film and stacked one upon another. The layers of organic materials comprise, in addition to a light-emitting layer, layers of materials capable of transporting holes such as a hole-injecting layer and a hole-transporting layer and layers of materials capable of transporting electrons such as an electron-transporting layer and an electron-injecting layer and organic EL devices comprising these layers have been proposed. The organic materials in these layers may be composed of low-molecular-weight compounds, high-molecular-weight compounds, or inorganic compounds.

Upon application of an electrical field to an organic EL device constructed of a laminate comprising a light-emitting layer and an electron- or hole-transporting layer, holes are injected from the anode and electrons are injected from the cathode. The holes and electrons recombine in the light-emitting layer to generate excitons and the excitons return to the ground state with emission of light, which is utilized by an organic EL device. The light-emitting layer is occasionally doped with a dye as a guest material to raise the luminous efficiency and secure stable driving of the device.

The use of a phosphorescent material, besides a fluorescent material, in the light-emitting layer has been proposed in recent years. In the light-emitting layer of an organic EL device, singlet excitons and triplet excitons are thought to be generated at the ratio in probability of 1:3 after recombination of electrons and holes; hence, a device utilizing phosphorescence or light emission by triplet excitons is expected to show a luminous efficiency 3 to 4 times as high as a device utilizing fluorescence or light emission by singlet excitons.

On the other hand, provision of a hole-blocking layer with an ability to restrict migration of holes from the organic light-emitting layer between the organic light-emitting layer and the cathode has been proposed for the purposes of lowering the power consumption, enhancing the luminous efficiency, and improving the driving stability of an organic EL device. Efficient confinement of holes in the light-emitting layer by means of this hole-blocking layer helps to raise the probability of recombination of holes and electrons and attain higher luminous efficiency. Phenanthroline derivatives and triazole derivatives are reported to be effective as a hole-blocking material.
Patent document 1: JP5-214332 A
Patent document 2: JP2001-237079 A
Patent document 3: JP2001-284056 A

It is reported in the patent document 1 that a complex of aluminum with a hydroxyquinoline compound and a phenolic compound (hereinafter referred to as AlQ2OR) is useful as an organic EL material for emission of blue light. This complex AlQ2OR has a structure constructed of two molecules of 8-hydroxyquinoline ligand, one molecule of phenolic compound ligand, and one aluminum atom. The patent document 1 discloses an example wherein light is emitted by incorporation of AlQ2OR in the electron-transporting layer.

A phosphorescent or fluorescent organic EL device comprising AlQ2OR in its hole-blocking layer is reported in the patent document 2. Moreover, a phosphorescent organic EL device in which an AlQ2OR-containing hole-blocking layer is provided between a phosphorescent light-emitting layer and an electron-transporting layer is reported in the patent document 3.

In the patent documents 2 and 3, (1,1′-biphenyl)-4-olato)bis(2-methyl-8-quinolinolato-N1,08)aluminum (hereinafter referred to as BAlq) obtained from 2-methyl-8-hydroxyquinoline as a hydroxyquinoline compound and 4-phenylphenol as a phenolic compound is cited as a concrete example of AlQ2OR. However, BAlq has a shortcoming of inferior hole-blocking ability as its ionization potential (Ip) is not sufficiently large although it shows excellent durability. For this reason, in the case where BAlq is used as a hole-blocking layer and tris(8-hydroxyquinoline)aluminum (hereinafter referred to as Alq₃) is used as an electron-transporting layer, it is the electron-transporting layer that emits light. In an organic EL device utilizing red phosphorescence, the emission of light (green) by Alq₃ leads to degradation of chromaticity. Therefore, what is desired in the case where AlQ2OR is used as a host material in an organic EL device comprising a phosphorescent material as a guest material in its light-emitting layer is to attain a long operating life while maintaining good luminous characteristics.

AlQ2OR has excellent properties as an organic EL material and organic EL devices using AlQ2OR exhibit excellent performance such as good luminous characteristics and long operating life. However, it has become clear that the use of an aluminum chelate complex such as AlQ2OR as an organic EL material in the production of an organic EL device causes a problem of the degree of vacuum becoming unstable in a film-forming chamber in the initial stage of vapor deposition. When the vapor deposition operation is performed while the degree of vacuum is still unstable, it is not possible to deposit films uniformly and the devices produced fluctuate in quality. If the vapor deposition operation is started after stabilization of the degree of vacuum, the problem of fluctuation in product quality can be solved, but a considerable loss is caused in organic EL material and operating time. From the viewpoint of quality control and production efficiency, the use of a material disturbing the degree of vacuum such as this is a serious obstacle to the practical production of organic EL devices. Even if a practical method were developed successfully by using such a material, the production cost would inevitably be affected adversely to a marked degree.

An aluminum complex such as AlQ2OR is a high-boiling substance and it cannot be analyzed by gas chromatography and, when high performance liquid chromatography (HPLC) is applied, the complex in question decomposes easily under the analytical conditions of HPLC. Thus, it has been difficult to analyze AlQ2OR quantitatively for purity and content of impurities. This means not only that what disturbs the degree of vacuum has not been clarified at all but also that even a management indicator for quality control of organic EL materials essential for the production of highly reliable organic EL devices has been completely absent.

### DISCLOSURE OF THE INVENTION

### Problems to be solved by the Invention

One of the themes of this invention is how to deal with the aforementioned problems. Accordingly, an object of this invention is to elucidate what causes the degree of vacuum to become unstable in a film-forming chamber in the initial stage of vapor deposition in the production of an organic EL device comprising AlQ2OR as an organic EL material and offer a means to overcome the difficulties involved. Another object of this invention is to maintain uniformity in performance of organic EL devices produced and to realize cost reduction by reducing the tact time in the production of organic EL devices by stabilizing the degree of vacuum in the film-forming chamber. A further object of this invention is to provide an organic EL material and an organic EL device using the said organic EL material, respectively producible on a large scale with high reliability in practical use, by establishing the aforementioned management indicator for quality control.

### Means to Solve the Problems

The inventors of this invention have conducted intensive studies to develop an organic El material consisting of AlQ2OR of high practicality and found that AlQ2OR prepared by the conventional method contains a specific impurity and the impurity is thermally unstable and decomposes easily when heated. The inventors have elucidated how the content of this specific impurity is related to the phenomenon of the unstable degree of vacuum in the film-forming chamber in the vapor deposition step and completed this invention. Thus, this invention relates to an organic EL material comprising an aluminum chelate complex represented by general formula (1) wherein the content of a complex represented by general formula (2) is 0.6 mol % or less;

L¹Al(L²)₂ (1)

wherein L¹ denotes a phenolate ligand and L² denotes an 8-quinolinolate ligand having at least a substituent at the 2-position, and

Al(L²)₃ (2)

wherein L² denotes an 8-quinolinolate ligand having at least a substituent at the 2-position.

Further, this invention relates to a method for producing the said organic EL material which comprises reacting an aluminum alkoxide with a quinolinol derivative, then with a phenolic compound to yield an aluminum chelate complex, and purifying the resulting aluminum chelate complex to reduce the content of a complex represented by general formula (2) to 0.6 mol % or less.

Further, this invention relates to an organic EL device comprising a layer formed by sublimation and vapor deposition of a material containing the said organic EL material.

Still further, this invention relates to a method for producing an organic EL device comprising 1) a step for synthesizing an aluminum chelate complex represented by general formula (1), 2) a step for purifying the said aluminum chelate complex by sublimation to yield the said organic EL material, and 3) a step for forming a film of the said organic EL material by vapor deposition.

This invention is described in detail below.

The organic EL material of this invention comprises an aluminum chelate complex represented by the aforementioned general formula (1) and, although the material may contain impurities in a very small amount, the content of the specific impurity must be kept below a certain level.

This aluminum chelate complex corresponds to AlQ2OR in the case where Q and L² are 8-quinolinolate ligands having at least a substituent at the 2-position and OR and L¹ are substituted or unsubstituted phenolate ligands.

Here, the 8-quinolinolate ligand having at least a substituent at the 2-position, for example, the one having a methyl or ethyl group at the 2-position, sterically hinders the aluminum atom from forming 3 or more bonds. The 8-quinolinolate ligand may additionally have one or more substituents at positions other than the 2-position. Such substituents include methyl, ethyl, propyl, phenyl, cyano, and trifluoromethyl groups.

The phenolate ligands include unsubstituted phenolate ligands such as phenolate, naphtholate, and phenanthrolate and substituted phenolate ligands having one or more substituents such as phenyl, naphthyl, phenanthryl, alkyl, and alkylphenyl groups. Although the substitution may take place at any position, the existence of a substituent at the 2-position is undesirable. The substituted phenolate ligands include phenylphenolate, naphthylphenolate, phenylnaphtholate, phenanthrylphenolate, phenylphenanthrolate, and naphthylnaphtholate. The number of carbon atoms in the alkyl group is preferably in the range of 1-6.

The organic EL material of this invention (hereinafter also referred to as aluminum chelate complex of this invention) is constituted of a quinolinol derivative and a phenolic compound. This organic EL material consisting of an aluminum chelate complex is used in an organic EL device, preferably as a host material or as a hole-blocking material in the light-emitting layer. The aluminum chelate complex represented by general formula (1) is produced, for example, by reacting aluminum isopropoxide with a quinolinol derivative and then with a phenolic compound in ethanol as reported in the patent document 1.

Two kinds of ligands are coordinated to aluminum at a molar ratio of 2:1 in the aluminum chelate complex represented by general formula (1). However, in the case where the quinolinol derivative has a substituent at the 2-position like 2-methyl-8-hydroxyquinoline, the steric effect produced by this substituent is thought to hinder three ligands of single kind from coordinating to aluminum to form a complex such as the one represented by general formula (2) and it is described in JP6-172751 A that tris(2-methyl-8-hydroxyquinoline)aluminum complex which is one kind of compound represented by general formula (2) could not be formed.

Thus, it has been an accepted view that a complex represented by general formula (2) does not form when 8-hydroxyquinoline having a substituent at the 2-position is used as a ligand in the synthesis of an aluminum chelate complex represented by general formula (1). In consequence, it has not been understood clearly what sort of adverse effects the contamination with a complex represented by general formula (2) would produce.

The inventors of this invention have found that the product obtained according to an ordinary method for producing an aluminum chelate complex represented by general formula (1) contains a complex represented by general formula (2) as a byproduct and, when the product containing this byproduct is used in the production of an organic EL device, the degree of vacuum becomes unstable in the film-forming chamber in the vapor deposition step. The inventors have further found that, when the aluminum chelate complex of this invention containing 0.6 mol % or less of a complex represented by general formula (2) is used in the production, of an organic EL device, there does not arise the problem of disturbance of the degree of vacuum in the film-forming chamber in the vapor deposition step.

A complex represented by general formula (2) is thought to decompose easily and, if it is present even in a small amount in an organic EL material, it decomposes to generate volatile gases in the vapor deposition step and likely affects most adversely the degree of vacuum in the film-forming chamber. When an aluminum chelate complex is produced by an ordinary method, the content of a complex represented by general formula (2) is 2.0 mol % or more and it is still 1.0 mol % or more even when purified by an ordinary method (recrystallization and purification by sublimation). Normally, an aluminum chelate complex represented by general formula (1); is synthesized and then purified by sublimation (in the purification step) prior to its use as an organic EL material. According to the studies conducted by the inventors of this invention, it is difficult to remove a complex represented by general formula (2) to such an extent as not to disturb the degree of vacuum by a single operation of purification by sublimation. However, repetition of purification by sublimation several times can produce the aluminum chelate complex of this invention containing 0.6 mol % or less of an impurity represented by general formula (2). According to this invention, the purification operation is conducted twice or more, preferably three times or more. Therefore, a preferable method comprises reacting an aluminum alkoxide with a quinolinol derivative, then with a phenolic compound to yield an aluminum chelate complex represented by general formula (1), conducting purification by a conventional method if necessary, and then conducting purification by sublimation several times.

A general method for producing an organic EL device comprises a preliminary step in which a TFT for driving an organic EL device, a color filter, a lower electrode, an insulating film, and the like are built up on a substrate such as a glass plate, a film-forming step in which an organic EL material and an upper electrode are formed in film on the lower electrode, and an encapsulating step in which an organic EL device is sealed from the air by an encapsulating cap or membrane. In the film-forming step, the organic EL material is submitted to vapor deposition in the evacuated film-forming chamber. A uniform thin film cannot be formed from the organic EL material when the degree of vacuum in the film-forming chamber is not stabilized. According to this invention, the use of an organic EL material purified in the aforementioned manner overcomes the problem of disturbance of the degree of vacuum in the film-forming chamber and enables one to form the organic EL material into thin film uniformly.

### BRIEF DESCRIPTION OF THE DRAWINGS

FIG. 1 illustrates the structure of an example of organic EL device produced according to this invention.

FIG. 2 illustrates the structure of a film-forming chamber in the vapor deposition step.

FIG. 3 illustrates the structure of an apparatus for purification by sublimation in the purification step.

### EXPLANATION OF SYMBOLS

11 Substrate; 12 lower electrode (anode); 13 organic hole-transporting layer; light-emitting layer: 15 electron-transporting layer; 16 upper electrode (cathode); 21 film-forming chamber; 22 substrate-holding unit; 23 valve; 25 film-forming source; 31 outer glass tube; 32 inner glass tube; 37 crude raw material; 33 mantle heater.

### PREFERRED EMBODIMENTS OF THE INVENTION

The aluminum chelate complexes suitable for use as organic EL materials in this invention are shown below, but they are not limited to these examples. The examples will help one to gain a better understanding of those quinolinolates and phenolates which are used in the synthesis of aluminum chelate complexes according to this invention. Any of the aluminum chelate complex thus synthesized contains an impurity represented by general formula (2) and the amount of this impurity is outside the range of 0-0.6 mol % unless elaborate or special purification is conducted.

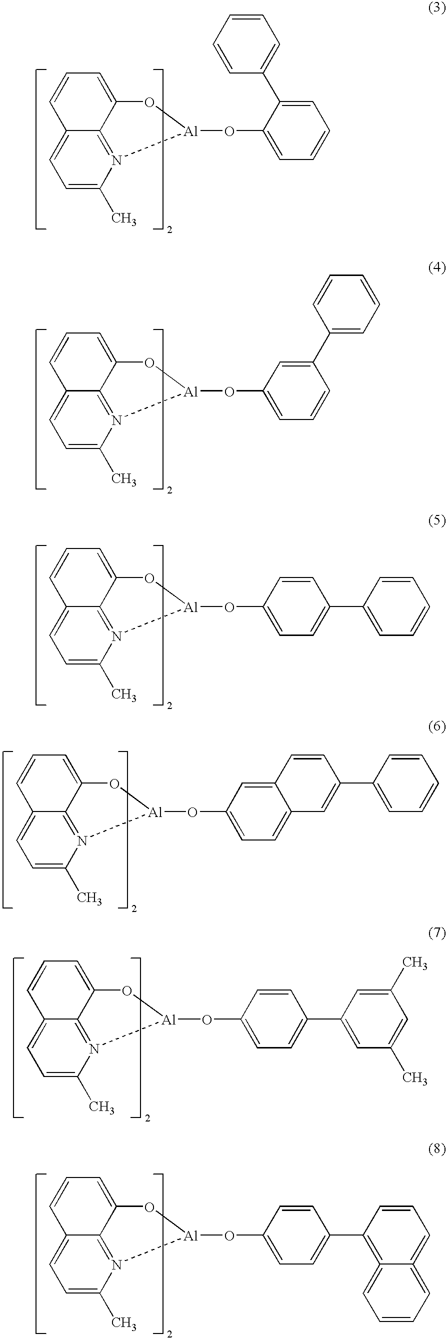

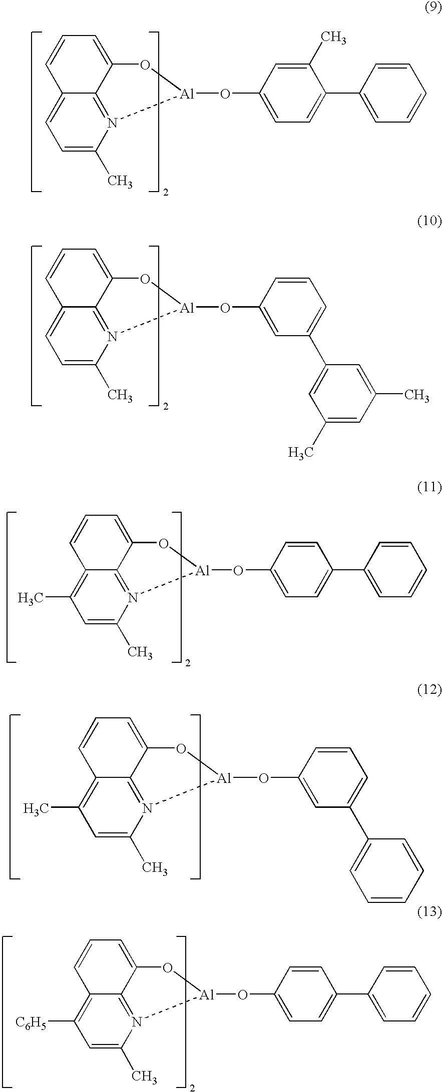

The aluminum chelate complex of this invention is used as an organic EL material in the electron-transporting layer, hole-blocking layer, light-emitting layer, and the like of an organic EL device, but it is preferably used in the light-emitting layer or hole-blocking layer. Advantageously, it is used as a host material of the light-emitting layer containing both host and guest materials. In this case, it is preferable to use a phosphorescent organic complex of a noble metal selected from ruthenium, rhodium, palladium, silver, rhenium, osmium, iridium, platinum, and gold as a guest material. An organic El device containing such host and guest materials in its light-emitting layer shows minimal degradation of luminous intensity with passage of time and also shows excellent reliability. Regardless of what is described above, it is allowable to use a luminous material such as a fluorescent material as a guest material.

The phosphorescent organic noble metal complexes useful as the aforementioned guest materials are shown below, but they are not limited to these examples.

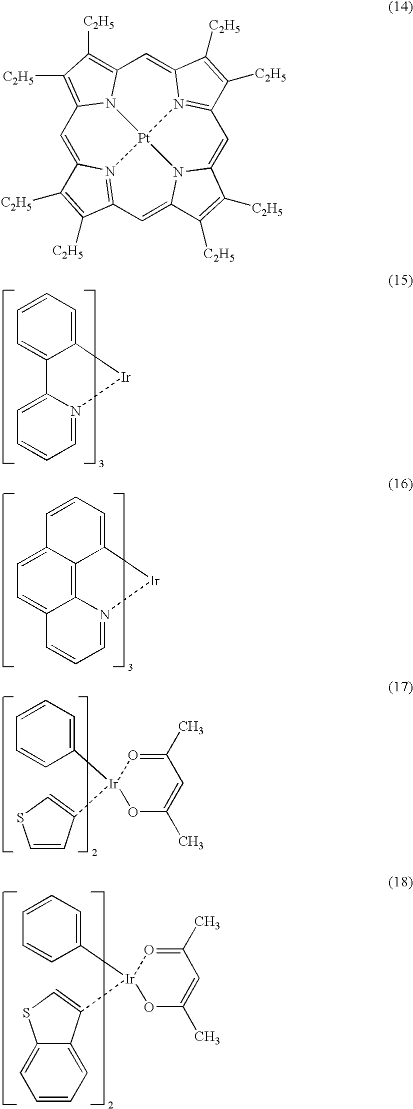

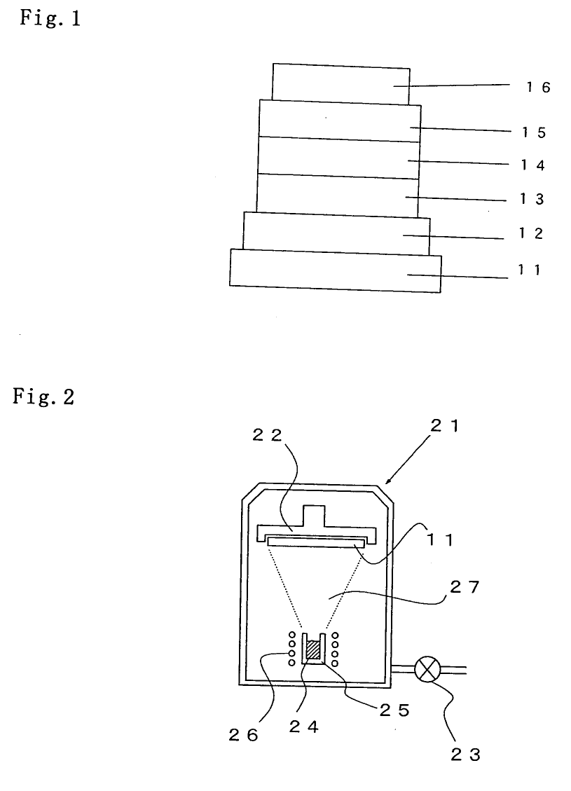

An organic EL device of this invention is described below with reference to FIG. 1 in which its layered structure is illustrated.

The organic EL device shown in FIG. 1 comprises a substrate 11, a lower electrode 12, a hole-transporting layer 13, a light-emitting layer 14, an electron-transporting layer 15, and an upper electrode 16. This device is constructed by stacking the lower electrode 12, the hole-transporting layer 13 of an organic compound, the light-emitting layer 14 of an organic compound, the electron-transporting layer 15 of an organic compound, and the upper electrode 16 one upon another on the glass substrate 11. In one example of this structure, indium tin oxide (hereinafter referred to as ITO) is used as the lower electrode 12 (anode), 4,4′-bis(N-naphthyl-N-phenylamino)biphenyl (hereinafter referred to as NPB) with an Ip of 5.4 eV as the hole-transporting layer, an organic EL material represented by general formula (1) of this invention as the light-emitting layer, Alq₃ as the electron-transporting layer, and aluminum as the upper electrode 16 (cathode).

A preferable structure comprises an electron-injecting layer formed in thin film from Li₂O or LiF and disposed between the electron-transporting layer 15 and the upper electrode 16. Another preferable structure comprises a hole-injecting layer formed from a porphyrin compound such as copper phthalocyanine (hereinafter referred to as CuPc) and disposed between the lower electrode 12 and the hole-transporting layer 13. The component contained in the hole-transporting layer 13 may be any substance capable of transporting holes. The lower electrode 12 and the upper electrode 16 may be set so that one functions as an anode and the other as a cathode. The anode is made from a material having a work function higher than that of a material for the cathode and the thickness is in the range of 600-5000 Å. Preferably, the anode is made from a transparent conductive film of metal oxide such as ITO and IZO, a film of metal such as silver, chromium, magnesium, nickel, platinum, aluminum, and gold and alloys thereof, or an amorphous semiconductor such as doped polyaniline and doped polyphenylenevinylene, respectively in monolayer or multilayer. In the case where the lower electrode 12 is set to function as a cathode, the layers of organic materials are stacked one upon another in the reverse order, that is, in the order of the lower electrode 12, the electron-transporting layer 15, the light-emitting layer 14, the hole-transporting layer 13, and the upper electrode 16.

The organic EL device of this invention can be applied to a device of bottom emission type where light is emitted from the side of the substrate 11 or to a device of top emission type where light is emitted from the opposite side.

The organic EL material constituting the light-emitting layer is either a single material or a combination of host and guest materials. The organic EL materials useful as the host materials include the aforementioned aluminum chelate complexes of this invention and the organic materials to be used as guest materials in combination with the said host materials are preferably phosphorescent organic noble metal complexes such as those cited above. If necessary, however, other materials may be incorporated in a small amount to the extent that does not ruin the effects of this invention. The ratio by weight of the guest material to the host material is in the range of 99.99:0.01 to 60:40.

A variety of known compounds such as Alq₃ may be used as materials to constitute the electron-transporting layer 15. The aluminum chelate complex of this invention may also be used as such material.

A hole-blocking layer may be provided and a variety of known materials such as Alq₃ may be used for it. Likewise, the aluminum chelate complex of this invention may be used here.

An example of the method for producing an organic EL device according to this invention is described below with reference to FIG. 2 illustrating the structure of a film-forming chamber. The symbols used in FIG. 1 are also used in the following description wherever they are common.

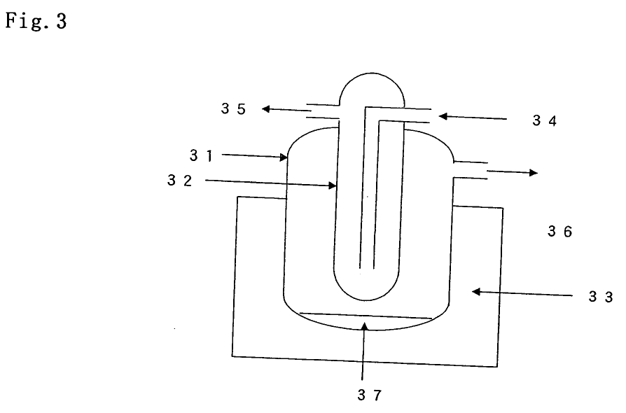

The substrate 11 on which the lower electrode 12 has been formed by film forming and patterning in the preliminary step is conveyed to a film-forming chamber 21 shown in FIG. 2 and is fixed in place by means of a substrate-holding unit 22. A valve 23 is connected to the film-forming chamber 21 and the pressure inside the film-forming chamber 21 is reduced to the prescribed level by the valve 23. A film-forming source 25 is filled with an organic EL material 24 which has been purified in an apparatus for purification by sublimation to be described later in FIG. 3. The film-forming source 25 is heated by a heating device 26 such as a resistance heater and the organic EL material is gasified by sublimation or vaporization. A gaseous film-forming material 27 is deposited in thin film on the substrate 11 to form the hole-transporting layer 13, the light-emitting layer 14, the electron-transporting layer 15, or the upper electrode 16. Thus, the film-forming operation conducted in the aforementioned manner in the film-forming chamber 21 is applicable to organic materials or electrode materials to be used in an organic EL device. A complex represented by the aforementioned general formula (2) is thought to decompose with ease and this complex existing in excess of a certain quantity in an organic EL material adversely affects the degree of vacuum in the film-forming chamber 21. However, the use of the organic EL material of this invention eliminates such adverse effects and enables one to form a uniform thin film.

### EXAMPLES

This invention is described in more detail below with reference to the accompanying examples.

### Synthetic Example 1

In a 500-ml three-necked flask equipped with a cooling tube, a thermometer, and a motor-driven stirrer were introduced 8.3 g of 2-methyl-8-quinolinol (a commercially available material with a purity of 98.0% or more), 10.7 g of aluminum isopropoxide, and 290 ml of dehydrated ethanol and the mixture was heated to the reflux temperature in a nitrogen atmosphere and heated there for 1 hour with stirring. The reaction mixture was cooled to room temperature and filtered through Celite to remove the insoluble matters. The mother liquor containing the reaction intermediate was transferred to a 500-ml three-necked flask equipped with a motor-driven stirrer, a solution of 8.9 g of p-hydroxybiphenyl and 8.3 g of 2-methyl-8-quinolinol in 75 ml of dehydrated ethanol was added slowly to the mother liquor at room temperature with stirring, and the mixture was stirred for 1 hour. The precipitate formed was collected by filtration, washed with ethanol and then with methanol, and dried under reduced pressure at 70° C. for 5 hours to give 22.5 g of compound (5) represented by formula (5). The compound (5) contained 2.0 mol % or more of a compound represented by general formula (2), that is, tris(2-methyl-8-quinolinolato)aluminum (hereinafter referred to as impurity A).

### Synthetic Example 2

In a 200-ml three-necked flask equipped with a cooling tube, a thermometer, and a motor-driven stirrer were introduced 6.4 g of 2-methyl-8-quinolinol (the same as used in Synthetic Example 1), 4.1 g of aluminum isopropoxide, and 100 ml of dehydrated ethanol and the mixture was heated to the reflux temperature in a nitrogen atmosphere and heated there for 1 hour with stirring. The reaction mixture was cooled to room temperature and filtered through Celite to remove the insoluble matters. The mother liquor containing the reaction intermediate was transferred to a 200-ml three-necked flask equipped with a motor-driven stirrer, a solution of 3.2 g of 2-methyl-8-quinolinol in 40 ml of dehydrated ethanol was added slowly to the mother liquor at room temperature with stirring, and the mixture was stirred for 1 hour. The precipitate formed was collected by filtration, washed with ethanol and then with methanol, and dried under reduced pressure at 70° C. for 5 hours to give 8.6 g of a solid. The solid was identified as tris(2-methyl-8-quinolinolato)aluminum (impurity A) by an NMR analysis.

### Purifying Example 1

The compound (5) obtained in Synthetic Example 1 was purified by sublimation four times in repetition. The purification by sublimation of 10.0 g of the compound (5) was performed in an apparatus for purification by sublimation shown in FIG. 3. The apparatus is constructed of an outer glass tube 31 and an inner glass tube 32; the outer glass tube constitutes a heating section and is heated by a mantle heater 33 while the inner glass tube 32 constitutes a collecting section and is cooled by nitrogen gas which is supplied through a tube 34 and discharged through a tube 35. The pressure inside the system is reduced to 2.0 Torr by a vacuum pump which is connected to the system by a tube 36, the heating section is heated to 360° C., and the purified compound (5) was collected on the outer wall of the inner glass tube 32. The compound (5) as a crude raw material 37 was introduced to the bottom of the outer glass tube 31. The procedure for collecting the purified compound in the collecting section was repeated four times and the purified compound A collected in the final purification operation amounted to 1.35 g. The purified compound A was confirmed by an NMR analysis to be free of impurity A which is a complex represented by general formula (2). The purified compound A is used as the aluminum chelate complex of this invention (organic EL material) in the examples.

### Examples 1-3 and Comparative Examples 1-2

Samples 1 to 5 were prepared as follows from the purified compound A obtained in the aforementioned Purifying Example 1.

Sample 1: purified compound A

Sample 2: purified compound A containing 0.4 mol % of impurity A obtained in Synthetic Example 2

Sample 3: purified compound A containing 0.6 mol % of impurity A obtained in Synthetic Example 2

Sample 4: purified compound A containing 0.8 mol % of impurity A obtained in Synthetic Example 2

Sample 5: purified compound A containing 1.0 mol % of impurity A obtained in Synthetic Example 2

It is to be noted that the samples 4 and; 5 were prepared for the sake of comparison.

An organic EL device was fabricated from each of the samples 1 to 5 by feeding 20 g of the sample to the vapor deposition source (film-forming source) and conducting vapor deposition at 1×10⁻⁴ Pa or below in the film-forming chamber as follows. The lower electrode was formed as a 2-mm stripe on a glass substrate by sputtering ITO to a thickness of 110 nm followed by patterning by etching. Then, a pattern of a photoresist AZ6112 (available from Tokyo Ohka Kogyo Co., Ltd.) was formed on the lower electrode. The glass substrate was washed with a surfactant, then washed with pure water, dried sufficiently at low humidity, and finally subjected to UV-ozone cleaning. This procedure constitutes the preliminary step.

The cleaned glass substrate was introduced to the film-forming chamber. After setting the degree of vacuum in the film-forming chamber at 1×10⁻⁴ Pa, CuPc was deposited at a rate of 0.5 nm/sec to a thickness of 25 nm by using a resistance heater to form a hole-injecting layer. Then, NPB was deposited at a rate of 0.5 nm/sec to form a hole-transporting layer in the same manner. Further, the aforementioned samples 1 to 5 were respectively deposited at a rate of 0.5 nm/sec to a thickness of 50 nm to form a light-emitting layer. Thereafter, Alq₃ was deposited at a rate of 0.5 nm/sec to a thickness of 30 nm to form an electron-transporting layer. Following this, LiF was deposited at a rate of 0.01 nm/sec to a thickness of 0.3 nm to form an electron-injecting layer. Finally, a shadow mask for cathode was applied and aluminum was deposited at a rate of 1 nm/sec to a thickness of 100 nm so that 2 mm-wide stripe of aluminum as an upper electrode crosses the stripe of the lower electrode at right angles. The above procedure constitutes the film-forming step. The light-emitting area of the organic EL device is the area formed by crossing of the ITO of the lower electrode and the aluminum of the upper electrode or 2 mm×2 mm.

The fluctuation in the degree of vacuum in the film-forming chamber in the vapor deposition step and the corresponding fluctuation in the performance of the product organic EL device were investigated. The fluctuation in the performance of the device is judged from the fluctuation in the voltage-luminance characteristics and the like of the organic EL device. The results are shown in Table 1.

The results are shown by markings of ⊚, ◯, x, and xx with the following meaning.

### [Fluctuation in the Degree of Vacuum]

⊚: No fluctuation at all in the degree of vacuum

◯: Slight disturbance in the degree of vacuum

x: Disturbance in the degree of vacuum

xx: Marked disturbance in the degree of vacuum

### [Fluctuation in the Performance of the Device]

⊚: No fluctuation at all in the performance

◯: Slight fluctuation, but tolerable in the practical use

x: Distinct fluctuation to lower the yield of devices and questionably suitable for practical use

xx: Marked fluctuation to degrade the performance of devices and not suitable for practical use

TABLE 1

| | | Content of | Fluctuation in | Fluctuation in |
|---|---|---|---|---|
| | | impurity A | degree of | performance of |
| | Sample | mol % | vacuum | device |
| Example 1 | 1 | 0.0 | ⊚ | ⊚ |
| Example 2 | 2 | 0.4 | ⊚ | ⊚ |
| Example 3 | 3 | 0.6 | ◯ | ◯ |
| Comparative | 4 | 0.8 | X | X |
| example 1 | | | | |
| Comparative | 5 | 1.0 | XX | XX |
| example 2 | | | | |

### Synthetic Example 3

In a 500-ml three-necked flask equipped with a cooling tube, a thermometer, and a motor-driven stirrer were introduced 26.8 g of 6-bromo-2-naphthol, 4.6 g of tetrakis(triphenylphosphine)palladium, and 100 ml of toluene and the mixture was stirred at 50° C. When the solid dissolved practically, a solution of 14.6 g of phenylboric acid in 100 ml of ethanol was added and the mixture was stirred. When the two solutions mixed, a solution of 30 g of sodium carbonate in 100 ml of water was added, the mixture was heated to the reflux temperature and heated there for 1 hour with stirring. Upon completion of the reaction, dilute hydrochloride acid was added to the reaction mixture until the aqueous layer turned weakly acidic, the organic layer was recovered, and the solvent was distilled off under reduced pressure. The crude product was recrystallized from 50 ml of toluene and the crystals collected by filtration were washed with toluene and dried at 80° C. under reduced pressure to give 11.9 g of 6-phenyl-2-naphthol.

### Synthetic Example 4

In a 500-ml three-necked flask equipped with a cooling tube, a thermometer, and a motor-driven stirrer were introduced 8.3 g of 2-methyl-8-quinolinol (a commercially available material with a purity of 98.0% or more), 10.7 g of aluminum isopropoxide, and 290 ml of dehydrated ethanol and the mixture was heated to the reflux temperature in a nitrogen atmosphere and heated there for 1 hour with stirring. The reaction mixture was cooled to room temperature and filtered through Celite to remove the insoluble matters. The mother liquor containing the reaction intermediate was transferred to a 500-ml three-necked flask equipped with a motor-driven stirrer, a solution of 11.5 g of 6-phenyl-2-naphthol obtained in Synthetic Example 3 and 8.3 g of 2-methyl-8-quinolinol in 75 ml of dehydrated ethanol was added slowly to the mother liquor at room temperature with stirring, and the mixture was stirred for 1 hour. The precipitate formed was collected by filtration, washed with ethanol and then with methanol, and dried under reduced pressure at 70° C. for 5 hours to give 27.9 g of compound (6) containing 2.0 mol % or more of impurity A.

### Purifying Example 2

The compound (6) obtained in Synthetic Example 4 was purified by sublimation four times in repetition. The purification by sublimation was performed by placing 6.0 g of the compound (6) in the apparatus used in Purifying Example 1, reducing the pressure in the system to 2.0 Torr, and setting the temperature of the heating section at 360° C. The purified compound collected in the collecting section was purified by repeating the same procedure four times. The compound finally collected or purified compound B amounted to 1.10 g and impurity A was not detected.

### Examples 4-6 and Comparative Examples 3-4

Samples 6 to 10 were prepared as follows from the purified compound B obtained in the aforementioned Purifying Example 2. It is to be noted that the samples 9 and 10 were prepared for the sake of comparison.

Sample 6: purified compound B

Sample 7: purified compound B containing 0.4 mol % of impurity A obtained in Synthetic Example 2

Sample 8: purified compound B containing 0.6 mol % of impurity A obtained in Synthetic Example 2

Sample 9: purified compound B containing 0.8 mol % of impurity A obtained in Synthetic Example 2

Sample 10: purified compound B containing 1.0 mol % of impurity A obtained in Synthetic Example 2

Each of the samples 6 to 10 was used as an organic EL material in the light-emitting layer of an organic EL device as in Example 1. The fluctuation in the degree of vacuum in the film-forming chamber in the vapor deposition step and the corresponding fluctuation in the performance of the device were investigated. The fluctuation in the performance was judged from the fluctuation in the voltage-luminance characteristics and the like of the device. The results are shown in Table 2 using the same markings as in Table 1.

TABLE 2

| | | Content of | Fluctuation in | Fluctuation in |
|---|---|---|---|---|
| | | impurity A | degree of | performance of |
| | Sample | mol % | vacuum | device |
| Example 4 | 6 | 0.0 | ⊚ | ⊚ |
| Example 5 | 7 | 0.4 | ⊚ | ⊚ |
| Example 6 | 8 | 0.6 | ◯ | ◯ |
| Comparative | 9 | 0.8 | X | X |
| example 3 | | | | |
| Comparative | 10 | 1.0 | XX | XX |
| example 4 | | | | |

It is apparent from Tables 1 and 2 that there is a strong interrelationship between the content of a complex represented by general formula (2) and the fluctuation in the degree of vacuum in the vapor deposition step and the fluctuation in the performance of the organic EL device produced and the fluctuations in both the degree of vacuum and the performance of the device are reduced markedly when the content of a complex represented by general formula (2) is reduced to 0.6 mol % or less.

### INDUSTRIAL APPLICABILITY

The use of the aluminum chelate complex of this invention stabilizes the degree of vacuum in a film-forming chamber in the vapor deposition step and enables one to produce efficiently a high-quality organic EL device which shows excellent reliability and durability in practical use. The method for producing the organic EL device provided by this invention enables one to increase the production efficiency, reduce the production cost, and exercise close quality control.

1-5. (canceled)

6. A method for producing an organic EL device which comprises
1) a step for synthesizing an aluminum chelate complex represented by general formula (1),
2) a step for purifying the said aluminum chelate complex by sublimation to yield an organic EL material whose content of a complex represented by general formula (2) is 0.6 mol % or less, and
3) a step for making the said organic EL material into film by vapor deposition;
L¹Al(L²)2 (1)
wherein L¹ denotes a phenolate ligand and L² denotes an 8-quinolinolate ligand having at least a substituent at the 2-position, and
Al(L²)3 (2)
wherein L² denotes an 8-quinolinolate ligand having at least a substituent at the 2-position.

7. A method for producing the organic EL device described in claim 6 wherein the organic EL material whose content of the complex represented by general formula (2) is 0.6 mol % or less is obtained by reacting an aluminum alkoxide with a quinolinol derivative and then with a phenolic compound and purifying the resulting aluminum chelate complex, the organic EL device has organic layers comprising a hole-transporting layer, a light-emitting layer, and an electron-transporting layer between the anode and the cathode, and the said light-emitting layer is formed from a material containing the said organic EL material by sublimation and vapor deposition.

8. A method for stabilizing the degree of vacuum of a film-forming chamber in the production of an organic EL device which comprises
1) a step for synthesizing an aluminum chelate complex represented by general formula (1),
2) a step for purifying the said aluminum chelate complex by sublimation to yield an organic EL material whose content of a complex represented by general formula (2) is 0.6 mol % or less, and
(3) a step for making the said organic EL material into film by vapor deposition;
L¹Al(L²)2 (1)
wherein L¹ denotes a phenolate ligand and L² denotes an 8-quinolinolate ligand having at least a substituent at the 2-position, and
Al(L²)3 (2)
wherein L² denotes an 8-quinolinolate ligand having at least a substituent at the 2-position.

9. A method for stabilizing the degree of vacuum of a film-forming chamber in the production of the organic EL device described in claim 8 wherein the organic EL material whose content of the complex represented by general formula (2) is 0.6 mol % or less is obtained by reacting an aluminum alkoxide with a quinolinol derivative and then with a phenolic compound and purifying the resulting aluminum chelate complex, the organic EL device has organic layers comprising a hole-transporting layer, a light-emitting layer, and an electron-transporting layer between the anode and the cathode, and the said light-emitting layer is formed from a material containing the said organic EL material by sublimation and vapor deposition.
